(19) United States
(12) Patent Application Publication
(10) Pub. No.: US 2014/0285696 A1
(43) Pub. Date: Sep. 25, 2014

(54) MICROLENS ARRAY RECOGNITION PROCESSOR

(71) Applicant: Kabushiki Kaisha Toshiba, Tokyo (JP)

(72) Inventor: Soichiro HOSODA, Kanagawa (JP)

(73) Assignee: KABUSHIKI KAISHA TOSHIBA, Tokyo (JP)

(21) Appl. No.: 14/017,241

(22) Filed: Sep. 3, 2013

(30) Foreign Application Priority Data
Mar. 22, 2013 (JP) 2013-059984

(51) Int. Cl. H04N 5/376; H04N 5/3745

(52) U.S. Cl. CPC H04N 5/376; H04N 5/37452
USPC 348/302; 348/294

(57) ABSTRACT

A processor for determining whether or not a first position of an image sensor corresponding to a pixel of an image sensor is included in areas of the image sensor corresponding to microlenses of the image sensor includes a cache configured to store one or more second positions of the image sensor corresponding to centers of the microlenses, each of the second positions being included in one or more of multiple regions defining an entire region of the image sensor, and a first controller configured to cause one or more of the second positions to be stored in the cache. Whether or not the first position is included in the areas corresponding to the microlenses is determined based on the second positions stored in the cache.

### CROSS-REFERENCE TO RELATED APPLICATION

This application is based upon and claims the benefit of priority from Japanese Patent Application No. 2013-059984, filed Mar. 22, 2013, the entire contents of which are incorporated herein by reference.

### FIELD

Embodiments described herein relate generally to a processor for determining whether or not a pixel of an image sensor is included in areas of the image sensor corresponding to microlenses of the image sensor.

### BACKGROUND

An image processing system including an image sensor and a microlens array is known to be used in a computational camera. In this system, the processor usually performs an ROI (region of interest) determination, which is a method for determining whether or not target pixels, which are to be processed in a predetermined order such as an order of a raster scan, are included within areas of the image sensor corresponding to the microlenses. This ROI determination is difficult when the microlenses are not uniformly arranged or when the microlenses are arranged with positioning errors.

In then image processing system of a the related art, the processor loads relevant microlens coordinate values one by one from a microlens coordinate memory, and compares the coordinate values of the target pixels with the loaded microlens coordinate values. In this case, the ROI determination requires a considerable amount of processing time.

### DESCRIPTION OF THE DRAWINGS

FIG. 1 schematically illustrates areas of an image sensor corresponding to a microlens array MLA, where each pixel of the image sensor is a target for an ROI search performed by a microlens array recognition processor according to an embodiment.

FIG. 2 illustrates a structure of a microlens array recognition processor according to the embodiment.

FIG. 3 illustrates components of microlens information processed in the microlens array recognition processor according to the embodiment.

FIG. 4 is a flowchart showing a cache-out control performed in the microlens array recognition processor according to the embodiment.

FIG. 5 illustrates states of state machines of the microlens array recognition processor according to the embodiment.

FIG. 6 is a flowchart showing calculation of lane numbers performed by a lane number calculator of the microlens array recognition processor according to the embodiment.

FIG. 7 illustrates a relationship between a coordinate space and an image area, from which data is processed according to the embodiment.

### DETAILED DESCRIPTION

According to an embodiment, a processor is directed to reduce a processing time for the ROI determination.

In general, according to one embodiment, a processor for determining whether or not a first position of an image sensor corresponding to a pixel of an image sensor is included in areas of the image sensor corresponding to microlenses of the image sensor includes a cache configured to store one or more second positions of the image sensor corresponding to centers of the microlenses, each of the second positions being included in one or more of multiple regions defining an entire region of the image sensor, and a first controller configured to cause one or more of the second positions to be stored in the cache. Whether or not the first position is included in the areas corresponding to the microlenses is determined based on the second positions stored in the cache.

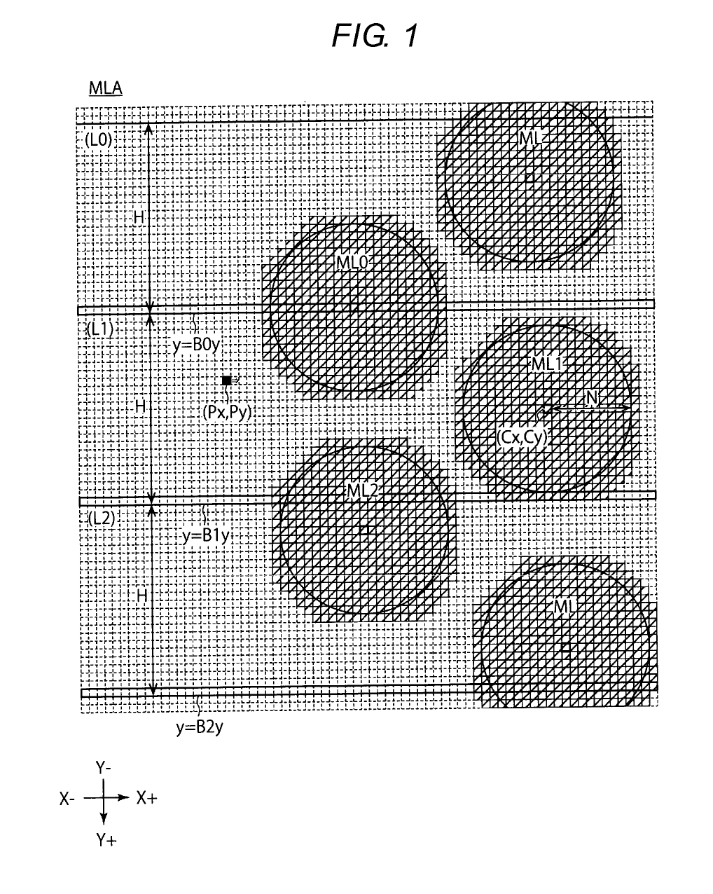

A microlens array MLA and ROI search according to an embodiment are hereinafter described. FIG. 1 schematically illustrates the microlens array MLA in this embodiment. Discussed herein is an example of demosaicing for an image of the microlens array MLA in the order of a raster scan. In FIG. 1, one grid corresponds to one pixel of an image sensor, and a position of the image sensor corresponding to each microlens ML of the microlens array MLA is defined by an X-Y coordinate space.

The microlens array MLA is formed of a plurality of microlenses ML arranged in a predetermined manner. Each of the microlenses ML has center coordinate values (Cx, Cy) and a radius N. The radius N may correspond to any number of pixels as long as the number is one or larger. The radius of the microlenses ML shown in FIG. 1 corresponds to 10 pixels, but the number of pixels is not limited to this number.

In a case in which a target pixel, of which pixel data is to be processed, is shifted in the order of the raster scan (from X− direction to X+ direction and from Y− direction to Y+ direction), at least three lanes L0 through L2, each having a fixed height H in the Y direction, are set in the X-Y coordinate space. The lane L1 is a lane containing a target pixel, which is defined by target coordinate values (Px, Py). The lane L0 is a lane disposed adjacent to the lane L1 in the Y− direction, while the lane L2 is a lane disposed adjacent to the lane L1 in the Y+ direction. According to this embodiment, exhaustive ROI search can be performed by setting pixels in the lane L1, and also pixels in the lanes L0 and L2 positioned adjacent to the lane L1 in the Y direction, as targets for the ROI search (i.e., setting coordinate values of the microlenses within the lanes L0 through L2 as targets for caching). While three microlens caches corresponding to the three lanes L0 through L2 are used in this embodiment, the number of the lanes and caches is not limited to this number but may be arbitrarily determined.

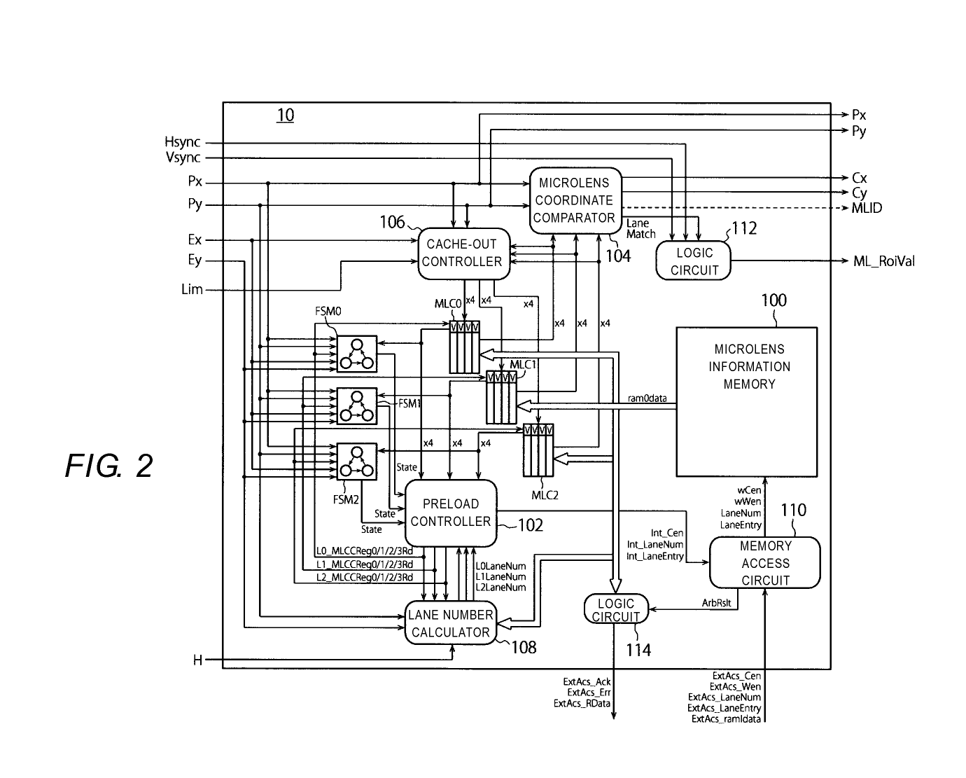

An example of a microlens array recognition processor according to this embodiment is explained as follows. FIG. 2 illustrates the structure of the microlens array recognition processor 10 according to this embodiment. The microlens array recognition processor 10 includes a microlens information memory 100, which stores microlens information containing coordinate values of the microlenses, a plurality of microlens caches MLC0 through MLC2 storing the coordinate values of the microlenses, a pre-load controller 102 pre-loading the coordinate values of the microlenses in the microlens caches MLC0 through MLC2, a microlens coordinate comparator 104 determining whether a target pixel is within the ROI, which corresponds to areas of the microlenses (each area of the microlens ML ranges from a center of the microlenses ML), a cache-out controller 106 removing unnecessary coordinate values of microlens ML from the microlens caches MLC0 through MLC2, a plurality of state machines FSM0 through FSM2 controlling states thereof based on which the pre-load controller 102 controls the pre-load, a lane number calculator 108 calculating the number of a lane, a memory access circuit 110 controlling access to the microlens information memory 100, and logic circuits 112 and 114.

For example, the microlens caches MLC0 through MLC2 are provided corresponding to the lanes L0 through L2, respectively. Each of the microlens caches MLC0 through MLC2 has a register capable of receiving four entries, or a memory such as an SRAM (static random access memory) accessible with a fixed latency.

In the following explanation, the microlenses ML0 through ML2 are collectively referred to as “microlenses ML” when appropriate. Similarly, the microlens caches MLC0 through MLC2 are collectively referred to as “microlens caches MLC,” the lanes L0 through L2 as “lanes L,” and the state machines FSM0 through FSM2 as “state machines FSM,” when appropriate.

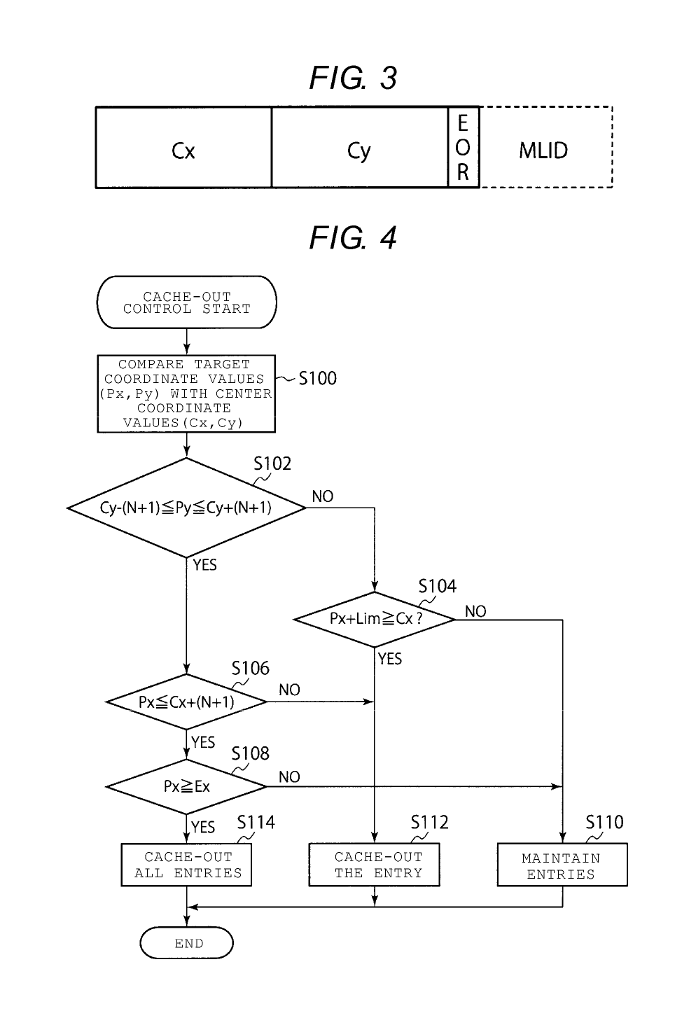

FIG. 3 illustrates components of the microlens information according to this embodiment. The microlens information contains the center coordinate values (Cs, Cy), an end flag EOR, and identification information MLID with respect to each of the microlenses ML. The microlens information is pre-loaded by the pre-load controller 102 in the microlens caches MLC, and output outside the microlens array recognition processor 10 by the microlens coordinate comparator 104. The identification information MLID may be omitted.

The microlens information memory 100 is divided into memory regions, each of which is associated with a corresponding lane L. A memory entry not including the center coordinate values (Cx, Cy) within a memory region (within a lane) is distinguished from an entry including effective coordinate values based on an end flag EOR (1-bit signal, for example).

A cache-out control performed by the cache-out controller 106 according to this embodiment is explained as follows. FIG. 4 is a flowchart showing the cache-out control in this embodiment. This cache-out control is performed with respect to each of the microlens caches MLC corresponding to the respective lanes L.

The cache-out controller 106 constantly compares target coordinate values (Px, Py) of the target pixel with the center coordinate values (Cx, Cy) stored in the microlens caches MLC (S100).

When it is determined as a result of the comparison in S100 that the target Y coordinate value Py of the target pixel is apart from the center Y coordinate value Cy by (N+2) or more pixels in the Y (Y+ and Y−) direction (S102-NO), the flow proceeds to S104. When NO in S102, any of the target pixels having coordinate value Py is not included in the ROI of the microlens ML indicated by the corresponding center coordinate values (Cx, Cy) in the processing in the order of the raster scan.

In this case, the cache-out controller 106 controls the microlens cache MLC to maintain the stored microlens coordinate values to avoid excessive pre-loading for the lanes L (S110) when the sum (hereinafter simply referred to as a “sum”) of the current target X coordinate value Px and a parameter Lim corresponding to the number of pixels in the X direction within which the microlens coordinate values are pre-loaded (hereinafter referred to as a “pre-load limit”) is smaller than the center X coordinate value Cx (S104-NO). On the other hand, when the sum is equal to or larger than the center X coordinate value Cx (S104-YES), the cache-out controller 106 determines that pre-loading for the lanes L is allowable and controls the microlens cache MLC to cache-out (remove) the stored microlens coordinate values from the microlens cache MLC (S112).

When the target Y coordinate value Py is within the range of (N+1) pixels in the Y direction from the center Y coordinate value Cy (S102-YES), the flow proceeds to determination in the X direction (S106).

When the target X coordinate value Px is away from the center X coordinate value Cx by (N+2) or more pixels in the X+ direction (S106-NO), the cache-out controller 106 controls the microlens cache MLC to cache-out the stored microlens coordinate values from the microlens cache MLC (S112). When NO in S106, any of the target pixels having the target Y coordinate value Py is not included in the ROI of the microlens ML indicated by the corresponding center coordinate values (Cx, Cy) in the processing in the order of raster scan.

When the target X coordinate value Px is within (N+1) pixels from the center X coordinate value Cx in the X+ direction (S106-YES) and is equal to or larger than a maximum X coordinate value Ex in the entire image area, of which pixel data is to be processed (S108-YES), the cache-out controller 106 controls the microlens cache MLC to cache-out the entire entries of the microlens cache MLC therefrom because the processing with respect to all pixels having the target Y coordinate value Py in the order of raster scan has been already finished (S114).

On the other hand, when the target X coordinate value Px is within (N+1) pixels in the X+ direction from the center X coordinate value Cx (S106-YES) and is smaller than the maximum X coordinate value Ex (S108-NO), there may be a target pixel having coordinate value Py that is included in the ROI of the microlens ML indicated by the corresponding center coordinate values (Cx, Cy) in the processing in the order of raster scan. Thus, the cache-out controller 106 controls the microlens cache MLC to maintain the stored microlens coordinate values (S110).

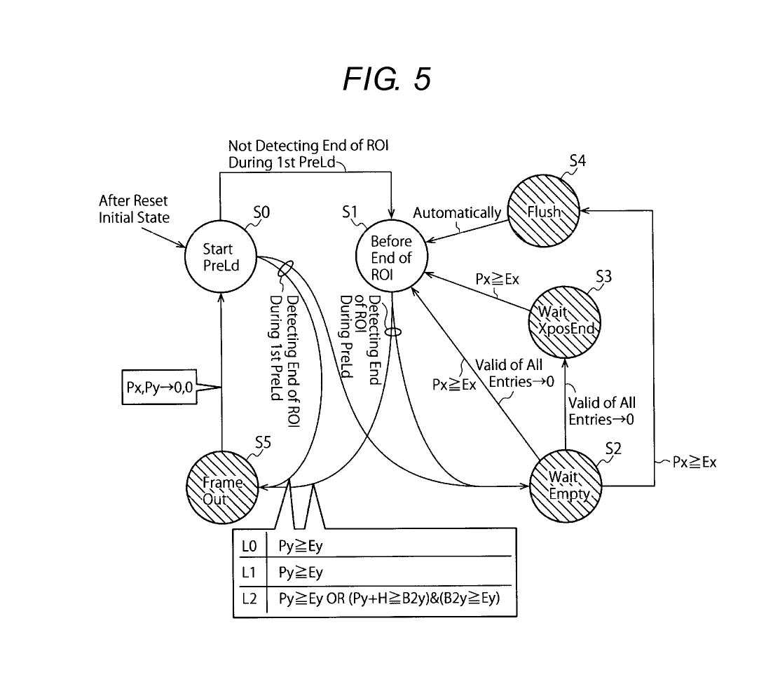

Control of states of the state machines FSM is explained as follows. FIG. 5 illustrates states of a state machine FSM of the microlens array recognition processor according to this embodiment. Each of the state machines FSM indicates the state for a corresponding lane. In the states shown in FIG. 5, each of states S0 and S1 is a state where the pre-load of the microlens information from the microlens information memory 100 is allowed as long as there is a vacant entry in the microlens cache MLC. On the other hand, each of states S2 through S5 is a state for prohibiting the pre-load.

After resetting, each of the state machines FSM goes into “Start PreLd” state S0. At this time, the pre-load controller 102 controls the memory access circuit 110 to read the microlens information (center coordinate values (Cx, Cy) and the end flag EOR)) from a memory region of the microlens information memory 100 corresponding to the respective lanes L, and causes the read information to be stored in the microlens cache MCL. When the end flag EOR is detected, the state machine FSM goes into “Wait Empty” state S2 because it indicates that the corresponding lane L of the frame does not contain the center coordinate values (Cx, Cy) of effective microlens ML. On the other hand, when the center coordinate values (Cx, Cy) are read without detection of the end flag EOR, the state machine FSM goes to “Before End of ROI” state S1.

When the end flag EOR is detected in the state S1, the state machine FSM goes into the state S2. In the state S2 and the subsequent states, as search for the center coordinate values (Cx, Cy) with respect to the corresponding lane L is finished, the state machine FSM checks whether or not the target X coordinate value Px exceeds the maximum X coordinate value Ex and whether or not the entire entries of the microlens cache MLC for the corresponding lane L have been cached-out from the microlens cache MLC while passing through the state S2, “Wait XposEnd” state S3, or “Flush” state S4. Then, the state machine FSM goes into the state S1.

In response to detection of the end of the frame, the condition for which is different with respect to each of the lanes L0 through L2, and of the end flag EOR, in the state S1, the state machine FSM goes into “Frame Out” state S5. The condition for the detection of the end of the frame with respect to the lane L0 and the lane L1 is “Py≧Ey”, while the condition for the detection of the end of the frame with respect to the lane L2 is “Py≧Ey” or“(Py+H≧B2y) and (B2y≧Ey)”. The value “Ey” is the maximum Y coordinate value in the entire image area, of which pixel data is to be processed, while the value “B2y” is a Y coordinate value of a boundary of lanes at the Y+ side of the lane L2.

In the state S5, the target coordinate values are set to (0,0), and the state machine FSM goes into the state S0 when the detection for the subsequent frame is ready.

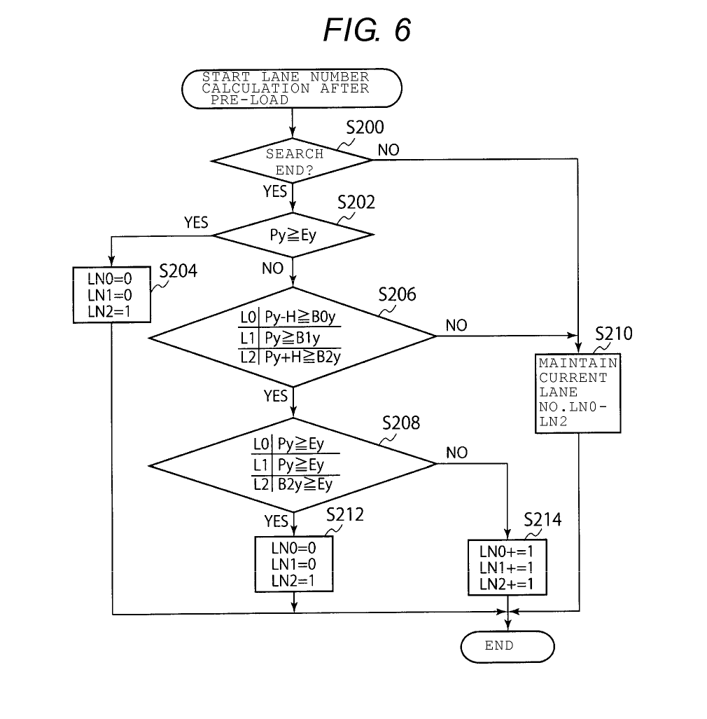

Calculation of lane number performed by the lane number calculator 108 according to this embodiment is explained as follows. FIG. 6 is a flowchart showing the calculation of the lane number in this embodiment. The “lane number” is information for specifying the lanes corresponding to the lanes L0 through L2, data acquired from which is to be processed, (memory regions of the microlens information memory 100 corresponding to the lanes). Lane numbers LN0 through LN2 shown in FIG. 6 are the lane numbers for the lanes L0 through L2, respectively, and correspond to “L0LaneNum” through “L2LaneNum” in FIG. 2 respectively.

When the end of the search with respect to one line in the X direction in the lanes L0 through L2 is detected based on the end flag EOR after the pre-load of the microlens information from the memory regions corresponding to the lane numbers LN0 through LN2 (S200-YES), the flow proceeds to S202. The lane number calculator 108 determines whether to maintain the current lane numbers LN0 through LN2 or increment the lane numbers. On the other hand, when the end of the search is not detected (S200-NO), the lane number calculator 108 determines that the target Y coordinate value Py in the subsequent line is included within the lanes specified by the current lane numbers LN0 through LN2, and maintains the current lane numbers LN0 through LN2 (S210).

When the target Y coordinate value Py is the maximum Y coordinate value Ey (S202-YES), the lane number calculator 108 determines that the search with respect to one frame is finished, and resets the lane numbers LN0 through LN2 to initial values (S204). As a result, the lane numbers LN0 and LN1 become “0”, while the lane number LN2 becomes “1”.

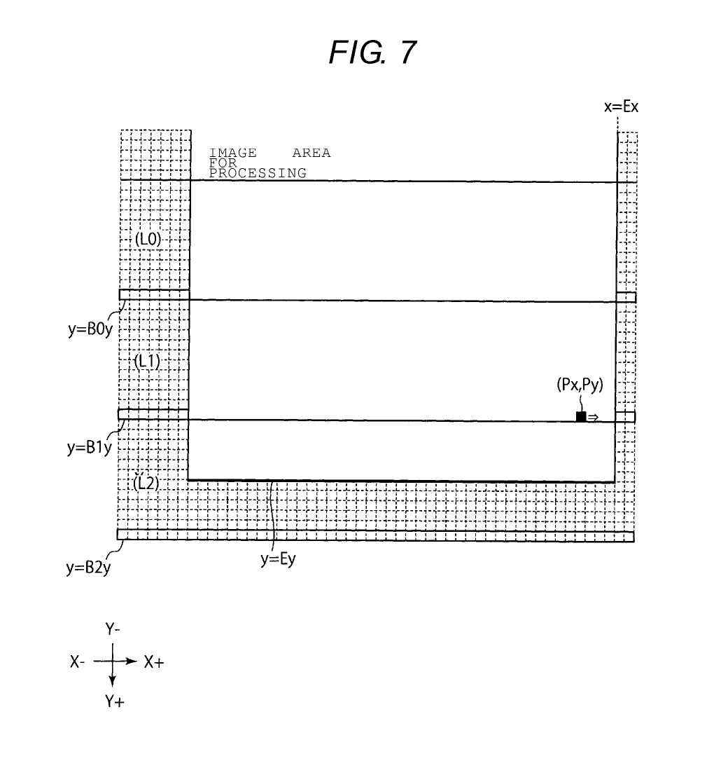

On the other hand, when the target Y coordinate value Py is smaller than the maximum Y coordinate value Ey (S202-NO), the lane number calculator 108 determines whether or not a first determining formula is satisfied with respect to each of the lanes L0 through L2 (whether or not the target Y coordinate value Py exceeds the boundaries of the lanes L0 through L2) by using the boundary Y coordinate values B0y through B2y of the lanes L0 through L2 (see FIG. 7) (S206). The first determining formula for the lane L0 is “Py-H≧B0y”. The first determining formula for the lane L1 is “Py≧B1y”. The first determining formula for the lane L2 is “Py+H≧B2y”.

When any of the first determining formulas is not satisfied (or the target Y coordinate value Py does not exceed any of the boundaries of the lanes L0 through L2) (S206-NO), the lane number calculator 108 determines that the target Y coordinate value Py of the subsequent line is contained within the current lane, and maintains the current lane numbers LN0 through LN2 (S210).

On the other hand, when one of the first determining formulas is satisfied (or the target Y coordinate value Py exceeds one of the boundaries of the lanes L0 through L2) (S206-YES), the lane number calculator 108 determines whether or not a second determining formula is satisfied (whether the search with respect to one frame is finished) with respect to each of the lanes L0 through L2 (S208). The second determining formula for the lanes L0 and L1 is “Py≧Ey”, while the second determining formula for the lane L2 is “B2y≧Ey”.

When one of the second determining formulas is satisfied (S208-YES), the lane number calculator 108 determines that the search with respect to the frame ends, and increments the lane number LN0 and LN1 and resets the lane number LN2 (S212). On the other hand, when any of the second determining formulas is not satisfied (S208-NO), the lane number calculator 108 determines that the search with respect to the frame is not finished, and increments the lane numbers LN0 through LN2 to shift the range of the search in the Y+ direction (S214). The second determining formula for the lanes L0 and L1 is different from the second determining relation for the lane L2 in S208, because the entire image area of the frame may not extend to the lane L2 (see FIG. 7, Ey<B2y).

The pre-load controller 102 pre-loads the microlens information stored in the microlens information memory 100 in accordance with the lane numbers LN0 through LN2.

Generally, the microlenses ML are fine and irregularly arranged, and therefore may be partly broken or deviated from designed positions. If only the lane L1 is set as a lane for examining whether or not the target pixel in the lane is included in the ROI in the order of raster scan, the ROI of the microlenses ML0 and ML2 of which center coordinate values are included in the lanes L0 and L2 may not be detected because of the irregular arrangement of the microlenses ML.

According to this embodiment, however, the microlens array recognition processor 10 establishes the three lanes L0 through L2 as the search target, and shifts the ranges of the three lanes L0 through L2 in the Y+ direction in conjunction with each other based on the cache-out policy. Accordingly, the microlens array recognition processor 10 can detect whether or not the target pixel is included in the ROI of not only one microlens but also of other microlenses within a short time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A processor for determining whether or not a first position of an image sensor corresponding to a pixel of an image sensor is included in areas of the image sensor corresponding to microlenses of the image sensor, comprising:
a cache configured to store one or more second positions of the image sensor corresponding to centers of the microlenses, each of the second positions being included in one or more of multiple regions defining an entire region of the image sensor; and
a first controller configured to cause one or more of the second positions to be stored in the cache;
wherein whether or not the first position is included in the areas corresponding to the microlenses is determined based on the second positions stored in the cache.

2. The processor according to claim 1, further comprising:
a second controller configured to control the cache to delete one or more of the second positions based on a correlation between the first position and the second positions stored in the cache.

3. The processor according to claim 2, wherein the second controller is configured to control the cache to delete all of the second positions in response to the first position being out of an area of the image sensor, image data acquired from which is to be processed.

4. The processor according to claim 2, wherein the second controller is configured to control the cache to delete one of the second positions in response to the first position being out of a predetermined range from the second position.

5. The processor according to claim 1, further comprising:
a memory configured to store all of the second positions,
wherein the first controller is configured to transfer one or more of the second positions stored in the memory to the cache.

6. The processor according to claim 1, further comprising:
a comparator configured to determine whether or not the first position is included in the areas of the image sensor corresponding to the microlenses based on the second positions stored in the cache and a radius of the microlenses.

7. The processor according to claim 1, further comprising:
a state machine configured to determine whether or not the cache has a space to store the second position, wherein
the first controller causes one or more of the second positions to be stored in the cache in response to the state machine determining that the cache has the space.

8. The processor according to claim 1, wherein
the first and second positions are defined in a coordinate of which first and second axes are along two sides of the image sensor, and
the multiple regions of the image sensor are divided along the first axis.

9. A method for processing data in a processor configured to determine whether or not a first position of an image sensor corresponding to a pixel of an image sensor is included in areas of the image sensor corresponding to the microlenses of the image sensor, the method comprising:
storing one or more second positions of the image sensor corresponding to centers of the microlenses, each of the second positions being included in one or more of multiple regions defining an entire region of the image sensor; and
determining whether or not the first position is included in the areas of the image sensor corresponding to the microlenses based on the stored second positions and a radius of the microlenses.

10. The method according to claim 9, further comprising:
deleting one or more of the second positions based on a correlation between the first position and the stored second positions.

11. The method according to claim 10, wherein
all of the stored second positions are deleted in response to the first position being out of an area of the image sensor, image data acquired from which is to be processed.

12. The method according to claim 10, wherein
one of the stored second positions is deleted in response to the first position being out of a predetermined range from the second position.

13. The method according to claim 10, wherein
one or more of the second positions are stored in a cache, and the method further comprising:
storing, in a memory, all of the second positions; and
transferring one or more of the second positions stored in the memory to the cache.

14. The method according to claim 9, wherein
one or more of the second positions are stored in a cache, and the method further comprising:
determining whether or not the cache has a space to store the second position, wherein
one or more of the second positions are stored in the cache in response to determining that the cache has the space.

15. The method according to claim 9, wherein
the first and second positions are defined in a coordinate of which first and second axes are along two sides of the image sensor, and
the multiple regions of the image sensor are divided along the first axis.

16. The method according to claim 9, further comprising:
processing the image data acquired by the image sensor based on determination of whether or not the first position is included in the areas of the image sensor corresponding to the microlenses.

17. An image sensing device comprising:
an image sensor comprising a plurality of pixels, each of which is configured to acquire image data;
a microlens array disposed along with the image sensor and including a plurality of microlenses;
a first processor configured to process the image data acquired by the image sensor; and
a second processor configured to determine whether or not a first position of an image sensor corresponding to a pixel of an image sensor is included in areas of the image sensor corresponding to the microlenses, the second processor comprising:
a cache configured to store one or more second positions of the image sensor corresponding to centers of the microlenses, each of the second positions being included in one or more of multiple regions defining an entire region of the image sensor; and
a first controller configured to cause one or more of the second positions to be stored in the cache,
wherein the second processor determines whether or not the first position is included in the areas corresponding to the microlenses based on the second positions stored in the cache.

18. The image sensing device according to claim 17, wherein
the second processor further comprises:
a second controller configured to control the cache to delete one or more of the second positions based on a correlation between the first position and the second positions stored in the cache.

19. The image sensing device according to claim 18, wherein
the second controller is configured to control the cache to delete all of the second positions in response to the first position being out of an area of the image sensor, the image data acquired from which is to be processed by the first processor.

20. The image sensing device according to claim 18, wherein
the second controller is configured to control the cache to delete one of the second positions in response to the first position being out of a predetermined range from the second position.
